(19) United States
(12) Patent Application Publication
(10) Pub. No.: US 2024/0177242 A1
(43) Pub. Date: May 30, 2024

(54) CENTRALIZED BUDGET MANAGEMENT SYSTEM AND METHOD

(71) Applicant: Rakuten Mobile, Inc., Tokyo (JP)

(72) Inventors: Anindita DATTA, Tokyo (JP); Hitomi WAKI, Tokyo (JP); Pranjal BAILUNG, Tokyo (JP)

(21) Appl. No.: 17/757,076

(22) PCT Filed: Mar. 3, 2022
(86) PCT No.: PCT/US2022/018628

§ 371 Date: Sep. 7, 2023

(51) Int. Cl. G06Q 40/12

(52) U.S. Cl. CPC G06Q 40/12

(57) ABSTRACT

A centralized budget management system (CBMS) includes a memory having non-transitory instructions; and processing circuitry configured to execute the instructions, thereby causing a graphical user interface (GUI), the GUI including a first user input field configured to receive a first user input identifying a person-in-charge (PIC) to log in to the CBMS; obtain master data from the memory; the GUI further including a table presentation of each existing budget application associated with the master data of the PIC; a second user input field configured to receive a second user input identifying an existing budget application to manage; a third user input field configured to receive a third user input identifying a draft budget document to import; a fourth user input field configured to receive a fourth user input identifying guided creation of a new budget document; and collect information from a draft budget document and unify the collected information.

### BACKGROUND

A budget is a financial plan for a defined period. A budget further includes planned sales volumes and revenues, resource quantities, costs and expenses, assets, liabilities, and cash flows. Companies, governments, families, and other organizations use a budget to express strategic plans of activities or events in measurable terms. A budget is the sum of finances allocated for a particular purpose and the summary of intended expenditures along with proposals for how to meet the intended expenditures. A budget includes a budget surplus, providing money for use at a future time, a deficit in which expenses exceed income, or a balanced budget where the expenses are equal to the income.

Often, an organization includes multiple departments, each of which includes multiple project-teams working on separate projects for a project manager. Typically, a person-in-charge (PIC) of a given department is responsible for managing the workflow of the department, and the PIC of a given project is responsible for managing the workflow of the project.

### BRIEF DESCRIPTION OF THE DRAWINGS

Aspects of the present disclosure are best understood from the following detailed description when read with the accompanying figures. In accordance with the standard practice in the industry, various features are not drawn to scale. The dimensions of the various features are arbitrarily increased or reduced for clarity of discussion.

FIG. 1 is a block diagram of a centralized budget management system (CBMS), in accordance with some embodiments.

FIG. 2 is a flowchart of a method for budget creation, in accordance with some embodiments.

FIG. 3 depicts a graphical user interface (GUI) for a login page, in accordance with some embodiments.

FIG. 4 depicts a budget creation GUI, in accordance with some embodiments.

FIG. 5 depicts a budget creation GUI, in accordance with some embodiments.

FIG. 6 depicts a budget creation GUI, in accordance with some embodiments.

FIG. 7 depicts a budget creation GUI, in accordance with some embodiments.

FIG. 8 depicts a budget creation GUI, in accordance with some embodiments.

FIG. 9 depicts a budget creation GUI, in accordance with some embodiments.

FIG. 10 depicts a budget creation GUI, in accordance with some embodiments.

FIG. 11 depicts a budget creation GUI, in accordance with some embodiments.

FIG. 12 depicts a budget creation GUI, in accordance with some embodiments.

FIG. 13 depicts a budget creation GUI, in accordance with some embodiments.

FIG. 14 depicts a budget creation GUI, in accordance with some embodiments.

### DETAILED DESCRIPTION

The following disclosure provides different embodiments, or examples, for implementing features of the provided subject matter. Specific examples of components, materials, values, steps, arrangements, or the like, are described below to simplify the present disclosure. These are, of course, examples and are not limiting. Other components, materials, values, steps, arrangements, or the like, are contemplated. For example, the formation of a first feature over or on a second feature in the description that follows includes embodiments in which the first and second features are formed in direct contact and includes embodiments in which additional features are formed between the first and second features, such that the first and second features are unable to be in direct contact. In addition, the present disclosure repeats reference numerals and/or letters in the various examples. This repetition is for the purpose of simplicity and clarity and does not dictate a relationship between the various embodiments and/or configurations discussed.

Further, spatially relative terms, such as “beneath,” “below,” “lower,” “above,” “upper” and the like, are used herein for ease of description to describe one element or feature's relationship to another element(s) or feature(s) as illustrated in the FIGS. The spatially relative terms are intended to encompass different orientations of the device in use or operation in addition to the orientation depicted in the FIGS. The apparatus is otherwise oriented (rotated 90 degrees or at other orientations) and the spatially relative descriptors used herein likewise are interpreted accordingly.

In some embodiments, multiple PICs are able to create and manage a budget (which include varying types of costs) with a centralized budget management system (CBMS). In some embodiments, a CBMS provides a user interface (UI) which allows multiple users to access, create, and manage the PIC's budget (e.g., department budget, project budget, or other suitable budgets within the contemplated scope of the disclosure) in a systematic (e.g., presented and formulated as a coherent body of budget ideas and principles) and unified manner (e.g., consistent with other PICs and company employees). In some embodiments, a PIC is able to create and manage a budget by importing and exporting a budgeting document (e.g., excel file, csv file, or other suitable spreadsheet within the contemplated scope of the disclosure), such as an initial budget draft. The created budget is then reviewed and approved by the responsible personal.

Traditionally, within an organization some PICS is able to simultaneously manage multiple budgets for multiple parties. In a non-limiting example, upper-tier PICs, such as in a financial department, review and manage multiple budgets for multiple departments. Continuing with the example, a lower-tier PIC, such as a department head, manages multiple budgets for multiple project teams, and other suitable projects within the contemplated scope of the disclosure. Conventionally, a department PIC (e.g., a dedicated person from the department, such as the department head, and other suitable managers within the contemplated scope of the disclosure) apply and obtain a budget amount for the department. In response to a project team applying for a project budget, the project team forwards a request along with details of the project to a project-team PIC (e.g., a dedicated person from the project team such as a project manager). A department PIC reviews details of a departmental budget to determine whether to approve the departmental budget. In response to a budget application being in good order, the department PIC (or project-team PIC) approves the budget application and forwards the budget application to the next-tier (e.g., a second tier) of review and approval, such as a financial department and/or upper management (e.g., a network department head, a business unit head, finance control department, a division head, a director of the board, or other suitable senior management within the contemplated scope of the disclosure). The department PIC then informs the project-team PIC regarding the upper management's decision.

In other approaches, budget creation and approval processes are burdensome, especially for the department PIC (particularly when the department PIC manages multiple project teams). Further, each of the multiple project teams submits information in a different style and format. This lack of uniformity results in difficulties and inefficiencies during the review of the budget applications. Before forwarding the budget application to the financial department and/or upper management, the department PIC is able to revise the submitted budget application into a unified style and format. In response to insufficient information provided by a project-team PIC, the department PIC returns the budget application to the project-team PIC requesting further information. This back-and-forth process results in multiple communications and causes delays in the budget application and approval.

In other approaches unifying the budget application and management processes is a difficult process. Unifying is challenging as different users have different levels of knowledge in the budget application and management process. In a non-limiting example, a new PIC who does not have experience in the budget application and management preparation process, has difficulty submitting each detail for the budget application. Continuing with the example, experienced PICs, who are familiar with the budget application process, already have a draft budget application used as a template for a budget application (e.g., the experienced user is able to add, change, and/or update information in the draft). Thus, inexperienced PICs who manually submit details of the budget application, are less efficient than experienced PICs.

In some embodiments, a CBMS allows a project-team PIC, regardless of budget experience, to create and manage a project budget in a systematic and unified manner. In some embodiments, a CBMS automatically forwards a project budget application to the associated next-tier PICs for approval, eliminating manual submission. In a non-limiting example, in response to the department PIC approving the project-team PIC's budget, the CBMS automatically updates the budget status from pending to approved and forwards the approved budget to another next-tier department, such as a financial PIC.

In some embodiments, a CBMS provides directed guidance for a budget application to the project-team PICS (e.g., who are inexperienced and unfamiliar with the budget application process). In some embodiments, this guidance is performed through direction within one or more user input fields including a suggested input for the PIC. In some embodiments, this guidance is performed through suggestive information within user input fields directing a PIC regarding the information to be inputted within the user input field. In some embodiments, this guidance is performed through pull-down windows that extend a new window downward with possible selections for the PIC. In some embodiments, this guidance is performed through the PIC entering a term or phrase within a user input field and the CBMS accessing a master data file of the PIC and providing suggestions to the PIC.

In some embodiments, experienced PICs who are familiar with the budget application process are able to import already created budget documents into the CBMS. In some embodiments, a CBMS simplifies the budget application process and improves user experience (UX) (e.g., how a user interacts with and experiences a product, system or service including a person's perceptions of utility, ease of use, and efficiency) with the budget application.

In some embodiments, a CBMS provides multiple options for PICs of all experience levels to create and manage budget applications according to their own preferences. Further, the CBMS directs the inputted information to create a uniform and systematic budget process. In a non-limiting example, a PIC who is inexperienced is guided through the budget process with a graphical user interface (GUI) displayed on a user interface (UI). In some embodiments, the GUI includes multiple user input fields with associated labelling and the user is able to input the information in each user input field based upon the associated labelling. In some embodiments, the PIC is able to input a keyword into the user input fields. A search is then performed based on the keyword for the available parameters (e.g., included in a database) most related to the PIC's information. The GUI then presents the available parameters (e.g., in the form of drop-down list (DDL), a drop-down menu, drop menu, pull-down list, picklist, or other suitable graphic control element within the contemplated scope of the disclosure) as a recommendation to the PIC. In some embodiments, the PIC is able to upload documents (e.g., documents describing details of the project, documents showing the personnel and/or materials involved, and other suitable budget documents within the contemplated scope of the disclosure) to assist in reviewing the budget application and approval. In a non-limiting example, these uploaded documents are evidentiary type documents to support line items in a budget process.

In some embodiments, an experienced PIC is able to create a draft budget template ahead of time (e.g., in excel file, csv file, or other suitable file within the contemplated scope of the disclosure) and then import the draft to the CBMS. The CBMS processes the imported draft and extracts data from the draft and imports the data into respective locations within the CBMS budget. In some embodiments, in response to a determination that the information included in the uploaded draft is sufficient, the CBMS creates a budget application based on the draft. In some embodiments, in response to receiving a draft budget application, the CBMS verifies whether the required information is sufficient (e.g., scans through the submitted information included in the draft, determines whether the draft is consistent with a pre-determined format, and other suitable uniformity and verification steps within the contemplated scope of the disclosure). In some embodiments, in response to the information being sufficient, the CBMS retrieves the information and insert the information into an application template, so as to create a draft application. In some embodiments, subsequently, the CBMS presents the draft application (e.g., in a list form) to the PIC for his review. In some embodiments, in response to the PIC determining that the draft is accurate and in good form, then the PIC clicks a submit button to submit the application.

Otherwise, the CBMS sends an error message (e.g., indicating which information is inaccurate and/or is missing) requesting the PIC to revise the draft and re-import the corrected draft or make corrections directly in the CBMS. In some embodiments, successful and failed budgets are recorded in a log file and the PIC is able to view the log file to understand what occurred to make the budget successful or failed.

In some embodiments, the CBMS simplifies the budget application and management process, which in turn increases efficiency of the budget creation process and reduces the burden on the PICs (e.g., those who apply for the budget, who review the budget, and other suitable personnel within the contemplated scope of the disclosure). In some embodiments, a CBMS unifies the budget application format, which in turn increases the efficiency of the approval process when department PICs review multiple budget applications. In some embodiments, a CBMS provides multiple options for budget applications and management (e.g., via a GUI or importing a draft), which in turn allows multiple PICs with different knowledge backgrounds to take part in budget application and management while maintaining budget uniformity.

In some embodiments, the CBMS is communicatively connected to a master data storage. In some embodiments, the master data storage includes data associated with each PIC of the CBMS. In some embodiments, the master data includes information about the PIC, such as the department and team of the PIC, the grade and role of the PIC, the location of the PIC, the project(s) which the PIC is currently handling and/or has handled in the past, the budget applications made by the PIC, and other suitable information is within the contemplated scope of the disclosure.

In some embodiments, in response to a PIC logging into the CBMS (e.g., by inputting an identification (ID) and password), the CBMS extracts the PIC's master data from the master data storage and processes the master data. In some embodiments, the CBMS presents a list of budget application(s) created by the PIC, wherein the list includes additional information of the created budget application(s) such as: the status (e.g., a current status), revision status (e.g., a status of a budget that has been revised), financial year for which the budget is applied, budget code, budget type, department name, total amount of the budget, the date of creation, and the like.

In some embodiments, a PIC manages (e.g., revises, deletes, and other suitable modifications within the contemplated scope of the disclosure) a budget application in the list, or creates a new budget application through CBMS guidance or by importing a draft file. In some embodiments, during creation of a new budget application, the PIC saves the application as a draft and continues to work on the draft at another time. In some embodiments, once the PIC completes the new budget application, the new budget application is forwarded to the next tier for reviewing and approving. In some embodiments, the new budget application is added to a list of budget application(s) associated to the PIC (e.g., created by the PIC, managed by the PIC, or other suitable associations to the PIC within the contemplated scope of the disclosure), and the status becomes pending for approval. In some embodiments, a budget code is generated for the new budget application and the budget code is associated with the new budget application within the master data.

In some embodiments, a department PIC applies and obtains a budget for his department before the project-team PIC applies for the project budget. In some embodiments, the project budget involves non-labor cost (e.g., material purchasing costs, equipment rental costs, and the like), labor costs (e.g., costs for hiring contractors or vendors, per diem costs, and the like), and a combination thereof. In some embodiments, the project-team PIC selects the type of cost(s) to be included in a budget application.

In some embodiments, once the budget application is created and submitted, the budget application is forwarded to respective personnel for approval. In some embodiments, the budget application is reviewed and is approved/rejected. In some embodiments, a PIC is able to edit a saved budget application or a budget application that has been rejected by a next-tier reviewer.

In some embodiments, a PIC or associated supervisory personnel (e.g., supervisor, manager, and other suitable manager within the contemplated scope of the disclosure) receives an e-mail notification sent by the CBMS once the CBMS determines there is a change in status of the budget application (e.g., change from pending, approved, rejected, saved, submitted, created, and other suitable status indicators within the contemplated scope of the disclosure).

In some embodiments, a CBMS and method are directed to automatically respond to a PIC input through a GUI. In some embodiments, the CBMS initiates a budget creation process. In some embodiments, the budget creation process includes validating a user as a PIC of the budget. In some embodiments, the CBMS verifies that a project budget is linked to a department budget or a project budget. In some embodiments, the CBMS creates a budget application from a file import or through guided UI, editing and storing labor and/or non-labor budget data. In some embodiments, the CBMS performs, automatically, an approval process based on the stored budget data.

Compared to the other approaches, the CBMS formats, stores, and standardizes budget data throughout an organization and the budget data is thereby efficiently managed by the PIC (e.g., project managers, and other suitable managers within the contemplated scope of the disclosure). The increased efficiency is provided based on the features of the various embodiments discussed herein being included in CBMS processing circuitry. By executing operations including automatically standardizing budget formats and linking project budgets to department budgets, the capabilities of the CBMS processing circuitry are improved such that the CBMS is useful to project managers compared to other approaches in which budget data is not uniformly formatted or controlled.

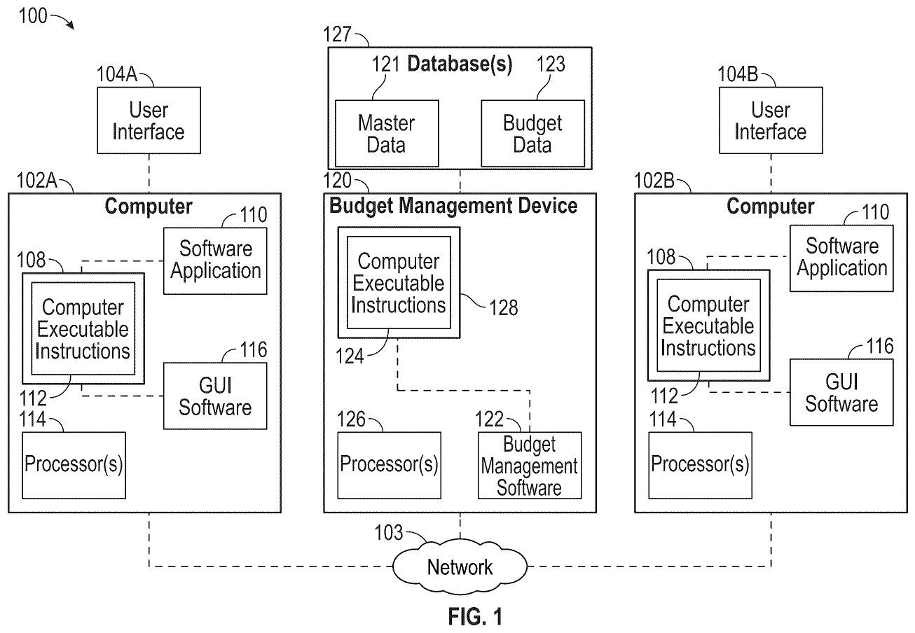

FIG. 1 is a block diagram of a centralized budget management system (CBMS) 100, in accordance with some embodiments.

CBMS 100 includes computers 102A, 102B (referred to generically or collectively as computer(s) 102) that are operably connected to user interfaces (UIs) 104A and 104B (referred to generically or collectively as UI 104). Computers 102 are connected to a budget management device 120 through a network 103 and are configured to manage the creation and editing of master data 121, for each CBMS user, and budget data 123 through user interface 104, and to communicate with budget management device 120 configured to store and retrieve master data 121 and budget data 123 in database(s) 127.

Computers 102 and budget management device 120 are communicatively connected to network 103 (e.g., through one or more wireless network interfaces such as BLUETOOTH, WIFI, WIMAX, GPRS, or WCDMA, one or more wired network interfaces such as ETHERNET, USB, or IEEE-884, or a combination thereof).

Computers 102 are communicatively connected (e.g., through a device interface) to respective UI 104. In some embodiments, several computers are present in CBMS 100. A UI is one or more input/output (I/O) devices capable of: displaying information communicated from processing circuitry to one or more PICs (e.g., through a GUI, and other suitable display methodologies within the contemplated scope of the disclosure), receiving input (e.g., by using a keyboard, a mouse, and/or other suitable means for receiving input in conjunction with a GUI, and other suitable peripheral device configured to put information into and get information out of a computer within the contemplated scope of the disclosure), and communicating the input to the processing circuitry (e.g., over one or more networks, and other suitable modes used to exchange messages between nodes within the contemplated scope of the disclosure). In various embodiments, UI 104 includes one or more I/O devices located at a single site or distributed over multiple sites (e.g., throughout a global organization, or different locations within a same region, and other suitable structures within the contemplated scope of the disclosure). In some embodiments, the UI is operably responsive to GUI software 116 discussed below.

In some embodiments, network 103 includes a wide area network (WAN) (i.e., the internet), a wireless WAN (WWAN) (i.e., a cellular network), a local area network (LAN), a wireless LAN (WLAN), a telecommunication network (e.g., 3G, 4G, LTE, 5G, and other suitable communication platforms are within the contemplated scope of the disclosure), or a combination thereof.

Computer executable instructions 112 are stored on non-transitory computer-readable medium 108 within each of computers 102. In some embodiments, a non-transitory computer readable storage medium (e.g., non-transitory computer-readable medium 108) is an electronic, magnetic, optical, electromagnetic, infrared, and/or a semiconductor read circuit (or apparatus or device). For example, a non-transitory computer readable storage medium includes a semiconductor or solid-state memory, a magnetic tape, a removable computer diskette, a random-access memory (RAM), a read-only memory (ROM), a rigid magnetic disk, and/or an optical disk. In some embodiments using optical disks, a non-transitory computer readable storage medium includes a compact disk-read only memory (CD-ROM), a compact disk-read/write (CD-R/W), and/or a digital video disc (DVD).

In some embodiments, forms of non-transitory computer-readable media include, for example, a floppy disk, a flexible disk, a hard disk, a magnetic tape, another magnetic medium, a CD-ROM, CDRW, DVD, another optical medium, punch cards, paper tape, optical mark sheets, another physical medium with patterns of holes or other optically recognizable indicia, a RAM, a PROM, an EPROM, a FLASH-EPROM, an EEPROM, a flash memory, another memory chip or cartridge, or another medium from which a computer reads. The term memory is used herein to refer to a non-transitory computer-readable medium.

Processing circuitry (e.g., one or more processors 114) include a central processing unit (CPU), a multi-processor, a distributed processing read circuit, an application specific integrated circuit (ASIC), a suitable processing unit, a field programmable gate array (FPGA), or a combination thereof. In some embodiments, the processing circuitry corresponds to one or more processors distributed within a cloud computing environment (e.g., over one or more server clusters).

In some embodiments, GUI software 116 supports forms of human-interface devices that allows users to interact with electronic devices through graphical icons and audio indicator such as primary notation, instead of text-based user interfaces, typed command labels or text navigation. The actions in a GUI are usually performed through direct manipulation of a graphical elements.

In FIG. 1, CBMS 100 includes one or more computers 102 and a budget management device 120. In some embodiments, CBMS 100 includes a single computer 102, more than two computers 102, and/or more than one budget management device 120. In some embodiments, budget management device 120 is containerized and distributed in a cluster of servers. These and other configurations for CBMS 100 are within the scope of this disclosure.

Computers 102 perform budget data & master data management (e.g., creation, modification, deletion, other suitable management functions within the contemplated scope of the disclosure), and device 120 functions to store and retrieve master data and budget data. Computer executable instructions 124 are stored on a non-transitory computer readable medium 128.

Budget management software 122 is configured to manage the creation, editing, and storing of budget data 123 in database(s) 127 in accordance with method 200 discussed below. In some embodiments, database(s) 127 is a building, a dedicated space within a building, or a group of buildings used to house computer systems and associated components, such as telecommunications and storage systems. IT operations include redundant or backup components and infrastructure for power supply, data communication connections, environmental controls (e.g., air conditioning, fire suppression), and various security devices.

To manage the creation, editing, and storing of budget data 123 in database(s) 127 and to perform other functions, computers 102 implement various software applications 110 and GUI software 116. Software applications 110 and GUI software 116 are provided as computer executable instructions 112 that are executable by processing circuitry 114 in each of computers 102.

Budget data 123 (e.g., department budget data or project budget data discussed below) are database elements including globally applicable, top-level budget data and itemized budget data corresponding to specific items within a given budget. Non-limiting examples of top-level budget data include department or project names or other identifiers, department or project descriptions, budget types or categories, fiscal years, PIC or other usernames, revision indicators, approval status indicators, total amounts, currency identifiers, cost center or other organizational section identifiers, account level identifiers, and other suitable information within the contemplated scope of the disclosure. Non-limiting examples of itemized budget data include time divisions such as months or quarters, location identifiers, measurement identifiers, item identifiers, item descriptions, unit prices, quantities, rental costs, rental durations, labor rates, labor hours, labor descriptions, outsourcing/contract costs, outsourcing/labor descriptions, team or group identifiers, account level indicators, item amounts, sub-total amounts, currencies, currency exchange rates, and other suitable budget information within the contemplated scope of the disclosure.

The database elements of budget data 123 are controlled by budget management software 122 through processing circuitry 126 as discussed below to have predetermined structures (e.g., data element size, range of values, and other suitable presentations within the contemplated scope of the disclosure) and relationships (e.g., hierarchies, validation links, and other suitable structures within the contemplated scope of the disclosure) whereby budgets created and maintained using CBMS 100 have standardized formatting and operational workflow.

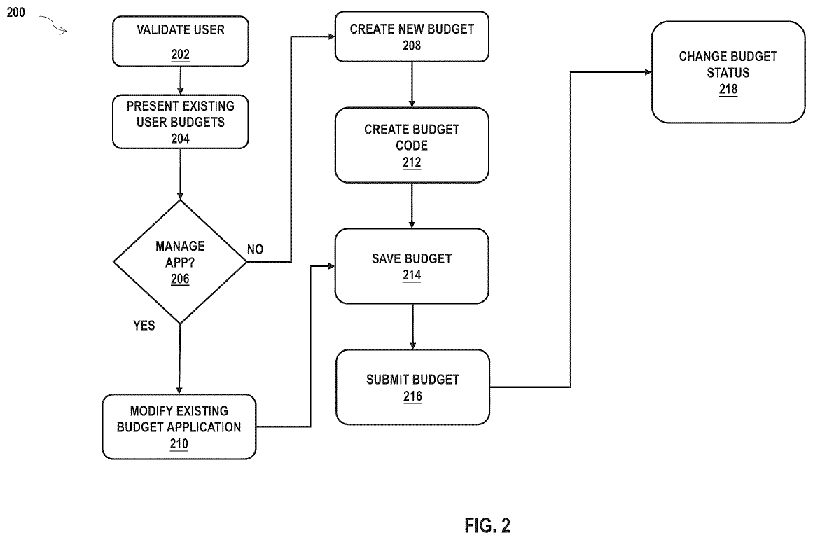

FIG. 2 is a flowchart of a method for budget creation 200, in accordance with some embodiments.

Method 200 is executed by processing circuitry 126 discussed above with respect to FIG. 1. In some embodiments, method 200 is executed by processors 114 through an application programming interface (API) which is a connection between budget management software 122. In some embodiments, method 200 is a method of creating and/or modifying a budget application from a UI, an uploaded form, an uploaded template, or other suitable user experience within the contemplated scope of the disclosure. In some embodiments, some, or all the operations of method 200 are executed in accordance with instructions corresponding to budget management software 122 discussed above with respect to FIG. 1.

Method 200 includes operations 202-218, but the operations are not necessarily performed in the order shown. Operations are added, replaced, order changed, and/or eliminated as appropriate, in accordance with the spirit and scope of disclosed embodiments. In some embodiments, one or more of the operations of method 200 are repeated. In some embodiments, unless specifically stated otherwise, the operations of method 200 are performed in order.

Method 200 is discussed with reference to FIGS. 2 and 3-14 that display multiple GUI in accordance with some embodiments. The discussion of these GUI embodiments are not exhaustive as other suitable GUIs are within the contemplated scope of the disclosure. Further, the appearance of each GUI is generic and one of ordinary skill in the art is able to contemplate other variations. Not all GUIs are necessary to the operation of CBMS 100 unless specifically stated otherwise. Further, a portion of GUI embodiments are not shown for the sake of brevity and conciseness. However, one of ordinary skill in the art is able to contemplate other GUIs that are able to be added to a systematic and uniform CBMS, such as CBMS 100.

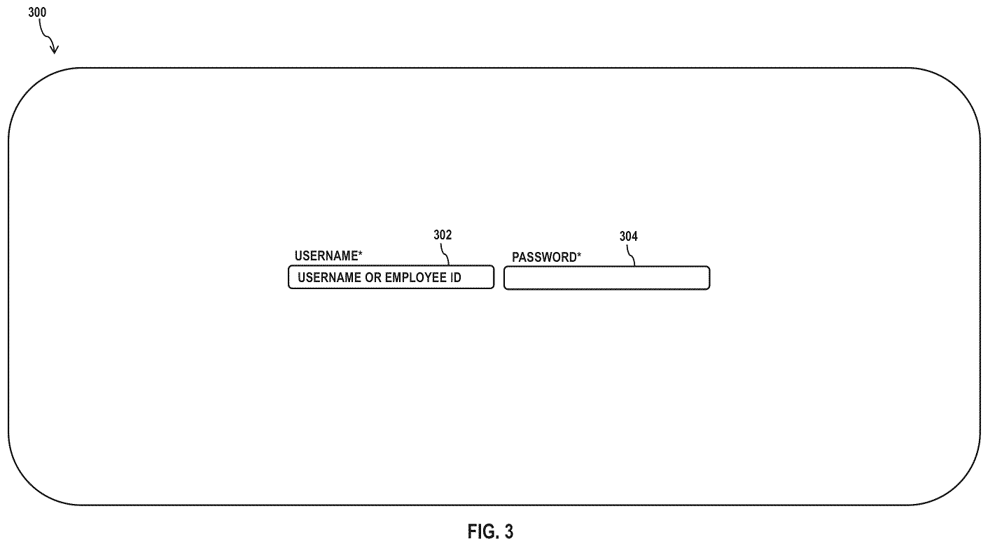

FIG. 3 depicts a budget creation GUI 300 for a login page, in accordance with some embodiments.

In operation 202 of method 200, a user is able to log into CBMS 100. In a non-limiting example, at GUI 300 (depicted in FIG. 3) a PIC is presented with user input fields 302 and 304. The PIC is able to input an ID (such as a username, employee ID, or other suitable identification within the contemplated scope of the disclosure) into user input field 302 and a password linked to the user in user input field 304. In response to CBMS 100 determining that the input ID and password are accurate, the CMBS 100 will grant access to the user.

In FIG. 2, CBMS 100 is in electronic communication with master data storage 121 that includes master data associated with each PIC (user) of CBMS 100. Master data 121 includes information for each PIC. The master data includes information of: PIC department and team of the PIC, the role of the PIC, the location where the PIC works, the project(s) that the PIC is currently handling and/or has handled in the past, and other suitable information within the contemplated scope of the disclosure.

In response to a PIC logging into CBMS 100 (e.g., by inputting identification (ID) at user input field 302 and a password at user input field 304), CBMS 100 extracts the PIC's master data from master data storage 121 and processes the master data. Process flows from operation 202 to operation 204.

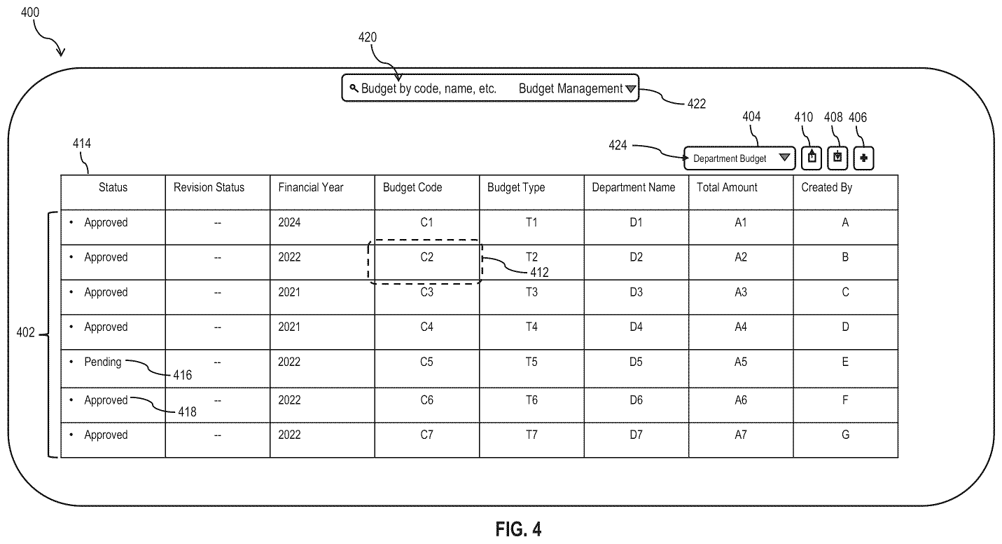

FIG. 4 depicts a budget creation GUI 400, in accordance with some embodiments.

In operation 204 of method 200, at GUI 400 CBMS 100 presents to the PIC a list 402 of budget application(s) created or being created and associated with the user. In a non-limiting example, in response to the user being a department head, list 402 includes applications created by his subordinates, different teams under the department head's department, or other suitable associations within the contemplated scope of the disclosure. In some embodiments, list 402 is blank as the PIC is a new user without ever submitting a budget. In some embodiments, list 402 includes additional information regarding the created budget application. This information includes: the status, revision status, financial year for which the budget is applied for, budget code, budget type, department name, total amount of the budget, the date of creation, and other suitable information within the contemplated scope of the disclosure.

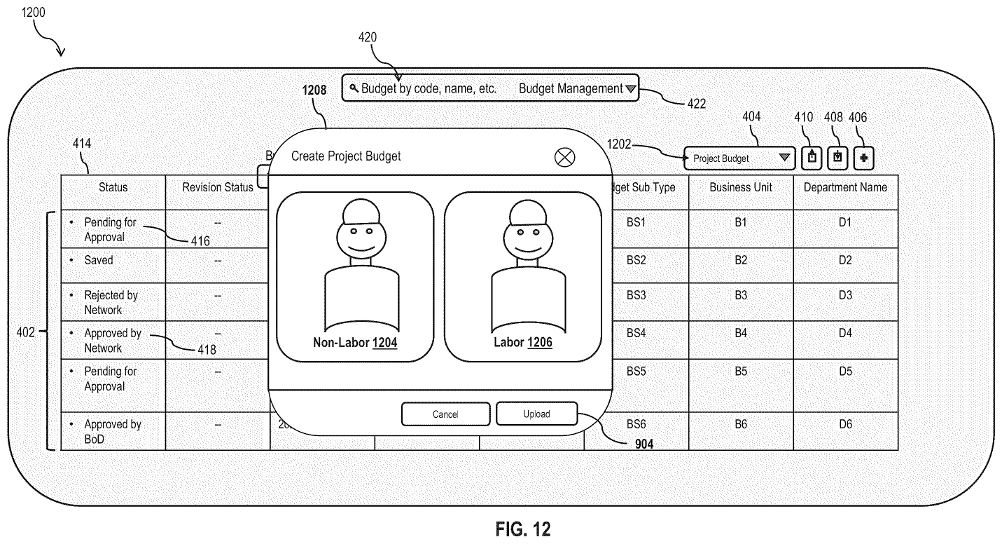

A PIC (not shown) is able to begin the creation of a budget from GUI 400 displayed on a UI, such as UI 104. In some embodiments, a PIC inputs (e.g., on a keyboard, mouse, touchscreen, voice-recognition, or other suitable interface within the contemplated scope of the disclosure) into user input field values or selects values from a user interface design presenting a list of options or commands to the user such as pull-down window 404. CBMS 100 is configured to allow a PIC to select a budget. In a non-limiting example, a PIC is able to select a budget (e.g., department budget 424, project budget (FIG. 12), or other suitable budget within the contemplated scope of the disclosure) through pull down window 404. In some embodiments, a PIC is unable to select a budget above the PIC's grade, pay scale, or authorization level.

In some embodiments, multiple PICs, at multiple UIs 104, or other suitable interface within the contemplated scope of the disclosure, are able to create, at operation 208, and manage, at operation 210, a budget with CBMS 100. Process flows from operation 204 to operation 206.

In operation 206 of method 200, the PIC is able to manage (e.g., revise, delete, and other suitable actions within the contemplated scope of the disclosure) a budget application in list 402 (“YES” branch of block 206). In a non-limiting example, the PIC, in addition to modifying a draft application (e.g., before submission), is further able to recall a submitted application, revise the application, and resubmit the revised application (e.g., modify a submitted application). In some embodiments, a PIC is able to select a row in list 402 and pull up a budget application to modify. In some embodiments, a PIC is unable to modify a budget that has been approved by a next-tier PIC above the PIC in the chain of command. The PIC is also able to create a new budget application (“NO” branch of block 206) through guided GUI navigation by clicking on user input button 406 or through importation of a draft budget file by clicking on user input button 408. Process flows from operation 206 to operation 208.

In operation 208 of method 200, an inexperienced PIC is able to click on user input button 406 to begin creation of a new budget application. Alternatively, an experienced PIC is able to click on user input button 408 to import a budget (e.g., excel file, csv file, of other suitable spreadsheet within the contemplated scope of the disclosure) the PIC has been working on. In some embodiments, a PIC is able to export a budget by clicking on user input button 410 to download an application(s) from list 402. In some embodiments, a PIC exports an application that is pending or rejected and this allows the PIC to work on the budget application offline and then upload the modified budget (e.g., with user input button 408). Process flows from operation 208 to operation 212.

In operation 212 of method 200, a unique budget code 412 is generated for the new budget application. In some embodiments, the unique budget code 412 is linked with the new budget application within master data 121. Budget code 412 is stored in master data 121 and is associated with the PIC that created or uploaded the budget application. In some embodiments, the new budget application is added to list 402 (in the event the new budget does not already currently exist on list 402).

In some embodiments, a suggested keyword 420 is in a user input field, such as user input field 422 that assists the PIC in understanding what is to be inputted into the user input fields. In some embodiments, the PIC is able to input a value into the user input fields and CBMS 100 searches for the most related available parameters based on the PIC's information from master data 121, and then presents the available parameters (e.g., in the form of drop-down-list, or other suitable presentation within the contemplated scope of the disclosure) as a recommendation to the PIC. In some embodiments, each user input field is configured with predictive text where one key or button represents search possibilities. Each key press results in a prediction rather than repeatedly sequencing through the same group of letters it represents. Predictive text allows for an entire word to be input by single keypress. Process flows from operation 212 to operation 214.

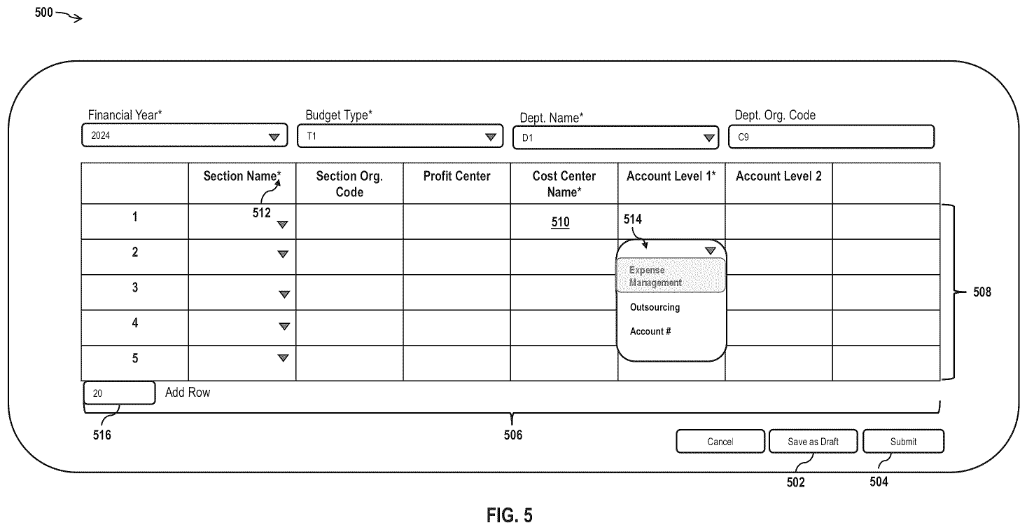

FIG. 5 depicts a budget creation GUI 500, in accordance with some embodiments.

In operation 214 of method 200, the PIC is further able to click on user input button 502 to save the budget application as a draft within database 127 and display on list 402. The PIC is able to continue to work (such as modifying or updating) on the budget application immediately (e.g., saving current progress and continue working) or at another time, such as at operation 210. Process flows from operation 214 to operation 216.

In operation 216 of method 200, in response to the PIC completing the budget application, the PIC is able to click on user input button 504 and the budget application is automatically submitted (for reviewing and approving) to a next-tier PIC.

In some embodiments, CBMS 100 is configured to receive user inputted values in cells within columns 506 and rows 508. In a non-limiting example, parameters (e.g., values, characters, or other suitable parameters within the contemplated scope of the disclosure) are entered by inputting information into a user input field, such as user input field 510 and other suitable user input fields within the cells are within the contemplated scope of the disclosure. In some embodiments, headings annotated with an asterisk 512 are user filed inputs that are configured to have inputs for the budget creation process to advance forward toward completion. In some embodiments, parameters are entered by selecting a suggestion or prediction, as discussed in FIG. 4. In some embodiments, a PIC is able to navigate, with a mouse, augmented reality, or other suitable tool within the contemplated scope of the disclosure, to a selection open a pull-down box 514 to indicate selections to the PIC. In some embodiments, user input field 516 allows a PIC to select how many rows to display. In some embodiments, a PIC is able to display up to 9990 rows from user input field 516. In some embodiments, a PIC is able to configure 10,000 rows to be displayed using user input field 516.

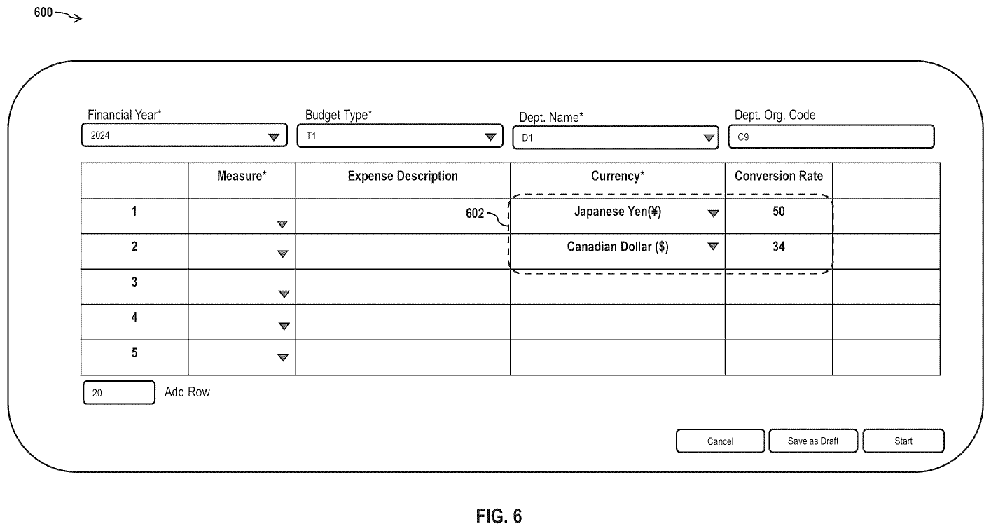

FIG. 6 depicts a budget creation GUI 600, in accordance with some embodiments.

In some embodiments, CBMS 100 allows a PIC to select a currency. In some embodiments, a network administrator sets a default currency for a PIC's first use (based on the location of the PIC, the nature of the department of the PIC, and other suitable parameters within the contemplated scope of the disclosure), and such configuration is stored in the master data of the PIC, such that when the PIC first access the CBMS 100 (e.g., GUI 600), CBMS 100 displays the default currency preset in the master data for the PIC. In some embodiments, the PIC is able to add a corresponding conversion rate for another currency against the preset default currency. In some embodiments, in user input fields 602, depending on the selection of the conversion currency, an exchange rate is automatically populated for the default currency that is set in CBMS general settings. In some embodiments, CBMS 100 is connected in real time to a currency conversion rate. In some embodiments, the currency conversion is obtained from the foreign exchange market (FOREX) in real time.

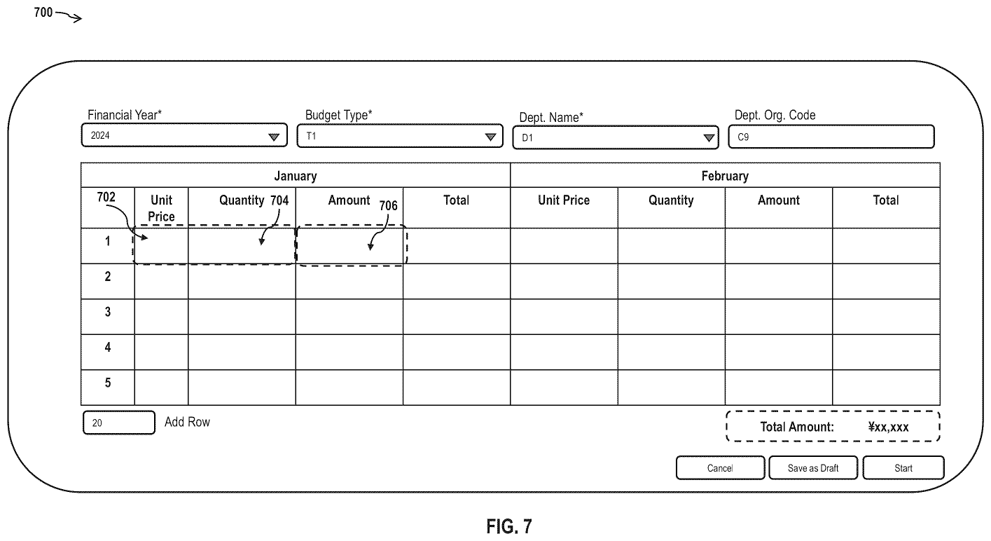

FIG. 7 depicts a budget creation GUI 700, in accordance with some embodiments.

In some embodiments, a PIC is able to input at user input field 702 and 704, a unit price and quantity. An amount, at field 706, is automatically calculated. In some embodiments, field 706 is a user input field and a PIC manually inputs the amount. In some embodiments, a manual input at field 706 is configured to be used when a unit price and/or quantity are not known (e.g., a vendor has not supplied requested information but has provided a cost). In some embodiments, the amount in field 706 is automatically converted to a default currency within the CBMS general settings. In some embodiments, a converted amount is shown in field 706.

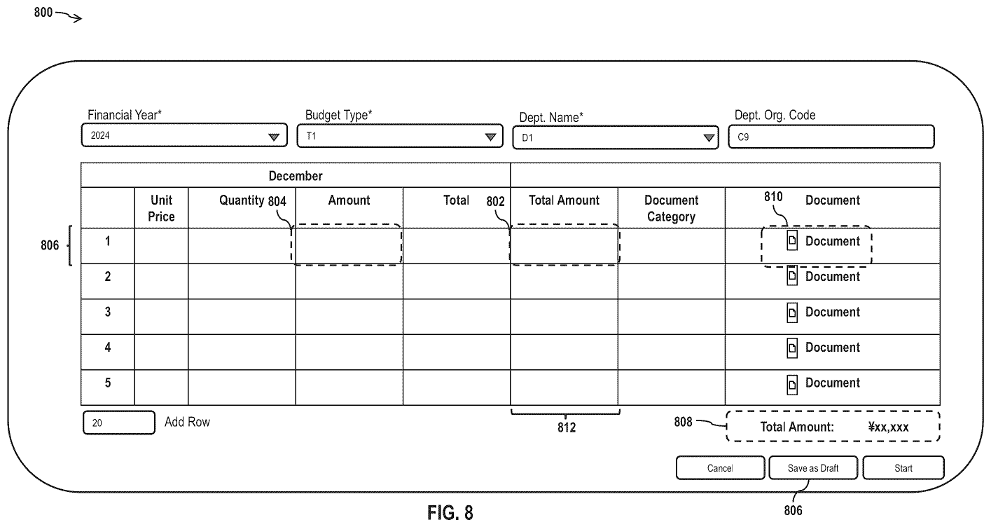

FIG. 8 depicts a budget creation GUI 800, in accordance with some embodiments.

In some embodiments, a total amount field 802 is automatically calculated and displayed based on, for example, a total number of months (e.g., January through December, or other suitable formats within the contemplated scope of the disclosure). In some embodiments, total amount field 802 is based upon each of amount field(s) 804 within row 806. In some embodiments, total amount field 802 is displayed in the default currency and auto calculated for each of the rows, below and including row 806. Further, an overall total amount in field 808 displays a grand total at the bottom of GUI 800. In some embodiments, an amount displayed in total amount field 808 is a sum of the amounts in column 812. Total amount field 808 is a total amount of each total amount field 802 for each column 812. In some embodiments, rows without an amount are assumed to have an amount of zero.

CBMS 100 is configured to allow for documents to be attached with user input button 810. In some embodiments, documents such as invoices, vendor bids, projected costs, projected revenues, offers for purchases, or other suitable budgetary materials within the contemplated scope of the disclosure are able to be uploaded as documents to support budget items. In some embodiments, the documents are evidentiary documents providing support for a specific budget item. In some embodiments, the PIC uploads documents (e.g., documents describing details of the project, documents showing the personnel and/or materials involved, or other suitable documents within the contemplated scope of the disclosure) to assist the budget approval PIC in reviewing the budget application.

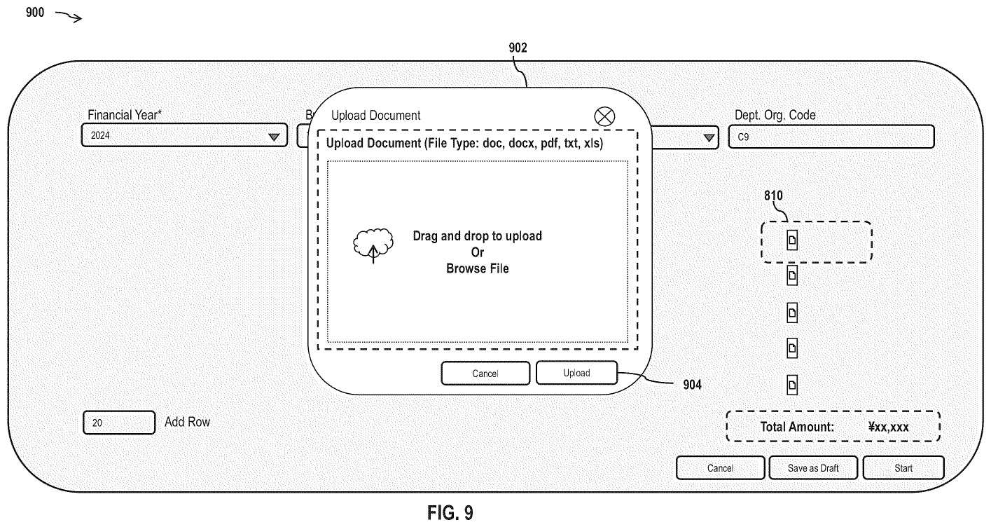

FIG. 9 depicts a budget creation GUI 900, in accordance with some embodiments.

In some embodiments, in response to a PIC selecting user input button 810, pop-up box 902 is displayed and configured to allow a PIC to drag and drop or browse for a file in which the PIC uploads a document. In some embodiments, the uploaded documents are related to the budget code. In some embodiments, the uploaded document is related to master data 121 of CBMS 100. In response to a PIC selecting a file to upload, the PIC is able to click on user input button 904 to upload the file to the budget in process

In some embodiments, UI 104 includes multiple GUIs, such as GUIs 300, 400, 500, 600, 700, 800, and 900. In some embodiments, each GUI is labeled clearly to allow the PIC to easily follow the budget process (e.g., a guided process). In some embodiments, this process creates a uniform budget that is more efficient for the reviewer to review and submit up through the chain of command. In some embodiments, the PIC inputs the information in each user input field of each GUI.

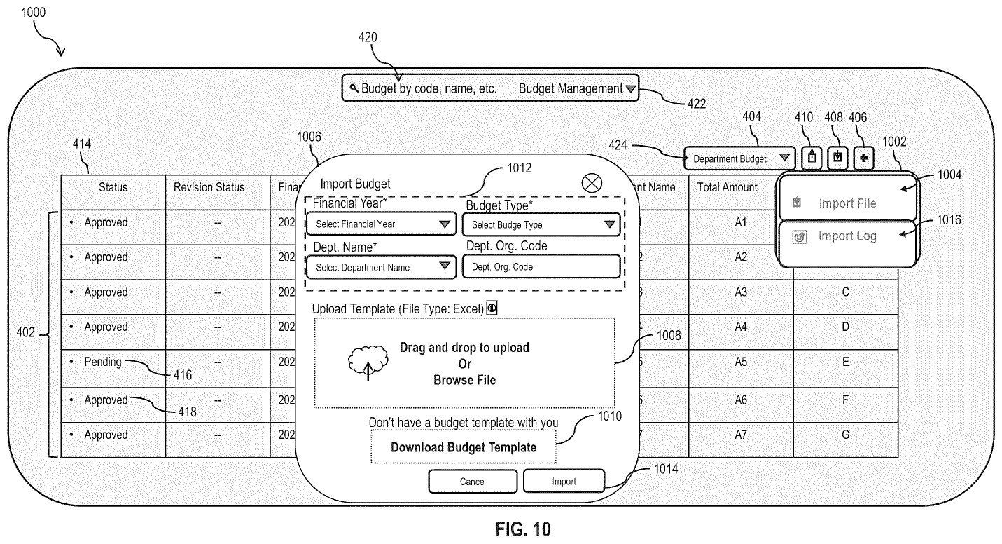

FIG. 10 depicts a budget creation GUI 1000, in accordance with some embodiments.

As stated above with reference to operation 208, an experienced PIC is able to import a pre-created budget application. In some embodiments, a PIC clicks on user input button 408 to open drop-down window 1002 that offers the PIC an option to import a file or to import a log file. In some embodiments, successful and failed records are recorded in a log file, and the PIC is able to view the log file to understand why the record was successful or why the record failed.

In some embodiments, instead of creating and managing the budget through the guided GUIs (such as GUIs 300, 400, 500, 600, 700, 800, and 900), the PICs are further able to create and manage a budget by importing (through user input button 408) and exporting (through user input button 410) budgeting documents (e.g., excel file, csv file, other suitable files within the contemplated scope of the disclosure). A PIC who has experience or is familiar with the budget application process is able to prepare a draft budget application (e.g., in excel file, csv file, other suitable files within the contemplated scope of the disclosure) and then import the draft to CBMS 100. In some embodiments, CBMS 100 processes the draft and in response to a determination that the information included in the draft is sufficient, CBMS 100 automatically creates a budget application based on the draft.

In some embodiments, in response to the PIC selecting import file tab 1004 pop-up box 1006 is opened. In some embodiments, the PIC is able to upload a file to box 1008 by drag/dropping or browsing for the file within master data 121. In some embodiments, the PIC is able to download or export a budget template at box 1010. The PIC is able to use the budget template to create draft budgets beforehand and upload later. In some embodiments, the PIC is able to upload a budget draft at box 1012 by inputting details about the budget draft such as, a financial year, budget type, department name, and department code. In some embodiments, the PIC, by clicking on user input button 1014, imports the selected file. In some embodiments, the imported file is automatically reflected in list 402.

CBMS 100 processes the uploaded draft and in response to a determination the draft budget information included in the draft is sufficient, CBMS 100 creates a budget application based on the draft. In some embodiments, in response to receiving a draft budget application, CBMS 100 verifies whether the required information is sufficient (e.g., scans through the submitted information included in the draft, determines whether the draft is consistent with a pre-determined format, and other suitable uniformity and verification steps within the contemplated scope of the disclosure). In some embodiments, in response to the information being sufficient, CBMS 100 retrieves the information and insert the information into an application template, so as to create a draft application. In some embodiments, subsequently, CBMS 100 presents the draft application (e.g., in a list form) to the PIC for his review. In some embodiments, in response to the PIC determining that the draft is accurate and in good form, then the PIC clicks a submit button to submit the application. In some embodiments, CBMS 100 sends an error message (e.g., a message at UI 104b indicating which information is inaccurate and/or is missing) to the PIC to request the PIC revise the draft and re-upload the corrected draft. The succeeded and failed records are recorded in a log file, and the PIC is able to view the log file by clicking box 1016 to understand the errors.

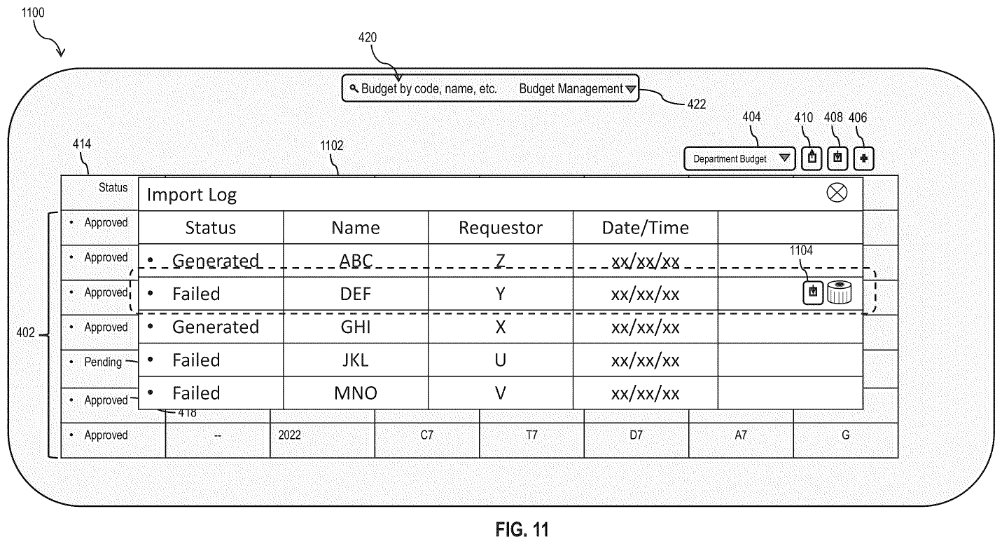

FIG. 11 depicts a budget creation GUI 1100, in accordance with some embodiments.

In some embodiments, an imported log pop up 1102 is generated when the PIC selects box 1016. The PIC is then able to download and check the details of any errors with user input button 1104.

In some embodiments, CBMS 100 simplifies the processes of budget application and management, which in turns increases efficiency and reduces the burden on PICs in budget application and management. In some embodiments, CBMS 100 unifies the budget application format, which in turns increases the efficiency of the approval in reviewing multiple budget applications. In some embodiments, CBMS 100 provides multiple options of budget application and management, which in turn allows multiple PICS with different knowledge background to take part in budget application and management.

In some embodiments, the department PIC has to apply and obtain a budget for the department before the project-team PIC applies for the project budget. The project budget involves non-labor cost (e.g., material purchasing costs, equipment rental costs, other suitable costs within the contemplated scope of the disclosure), labor costs (e.g., costs for hiring contractors or vendors, per diem costs, other suitable costs within the contemplated scope of the disclosure), and a combination thereof. The team PIC selects the type of cost(s) to be included in a budget application though UI 104.

FIG. 12 depicts a budget creation GUI 1200, in accordance with some embodiments.

In one embodiment, CBMS 100 provides GUI 1200 which allows multiple PICS to access, create, and manage budgets (e.g., department budget 424, project budget 1202, and other suitable budgets are within the contemplated scope of the disclosure) in a systematic and unified manner. CBMS 100 allows a project-team PIC to apply a project budget in a systematic and unified manner. In some embodiments, CBMS 100 forwards the project budget application to the associated next-tier PIC for approval. In some embodiments, the department PIC applies and obtains a budget for his department before the project-team PIC is able to apply for the project budget. In some embodiments, the project budget involves non-labor cost 1204 (e.g., material purchasing costs, equipment rental costs, and other suitable material costs are within the contemplated scope of the disclosure), labor costs 1206 (e.g., costs for hiring contractors, vendors, per diem costs, and other suitable labor costs are within the contemplated scope of the disclosure. In some embodiments, the project-team PIC selects the type of cost(s) (e.g., non-labor 1204 or labor 1206) to be included in a budget application in pop-up box 1208 after the PIC selects project budget 1202.

Other approaches only allow department PICs to plan department budgets but does not allow the project-team PICs to plan the project budgets. Further, other approaches do not provide any project budget related features (e.g., allow project-team PICs to input labor costs/non-labor costs, and other suitable project related costs within the contemplated scope of the disclosure).

In some embodiments, a project-team PIC selects project budget 1202 in pull-down window 404. In some embodiments, a project-team PIC clicks on user input button 106 to begin a non-labor or labor budget. Once pop-up box 1208 is visualized, the project-team PIC is able to select either non-labor 1204 or labor 1206 for the desired budget.

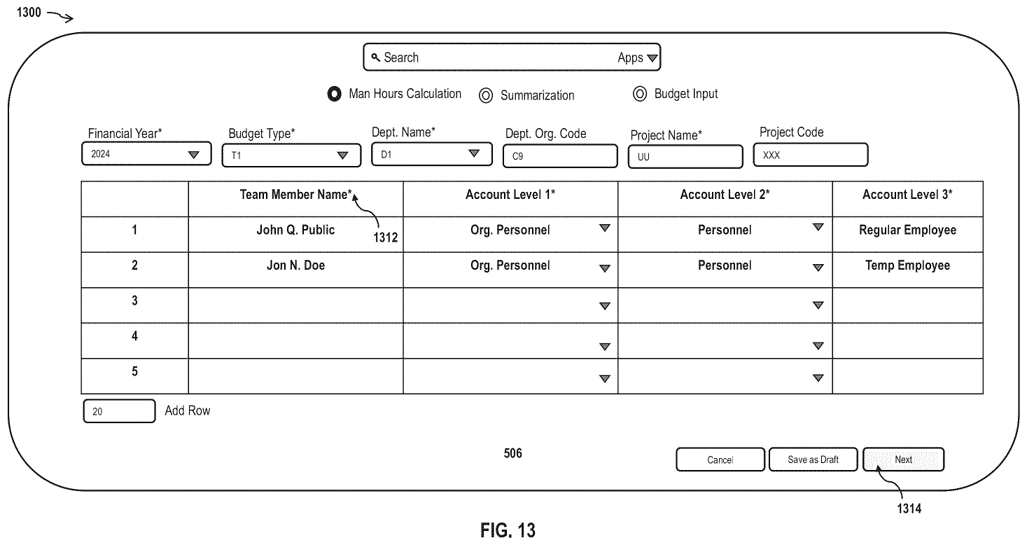

FIG. 13 depicts a budget creation GUI 1300, in accordance with some embodiments.

As with the department budget, user input fields with an asterisk 1312 are used to indicate an entry is helpful in moving the budget to the next step. Further, as with the department budget, values within the user input fields are entered either by typing in a value, selecting from a suggestion within the user input field, a pull-down box, predictive text, or other suitable predictor within the contemplated scope of the disclosure. In some embodiments, a project-team PIC is able to input a personnel's hourly pay rate, estimated house and have a total cost automatically determined. After the project-team PIC clicks on user input button 1314 man-hours data calculations are saved.

In some embodiments, the project budget is like the department budget in that the project-team PIC is able to upload documents to support budget items, save drafts of a project budget, submit a project budget, edit budgets, select currencies, and other suitable similarities are within the contemplated scope of the disclosure.

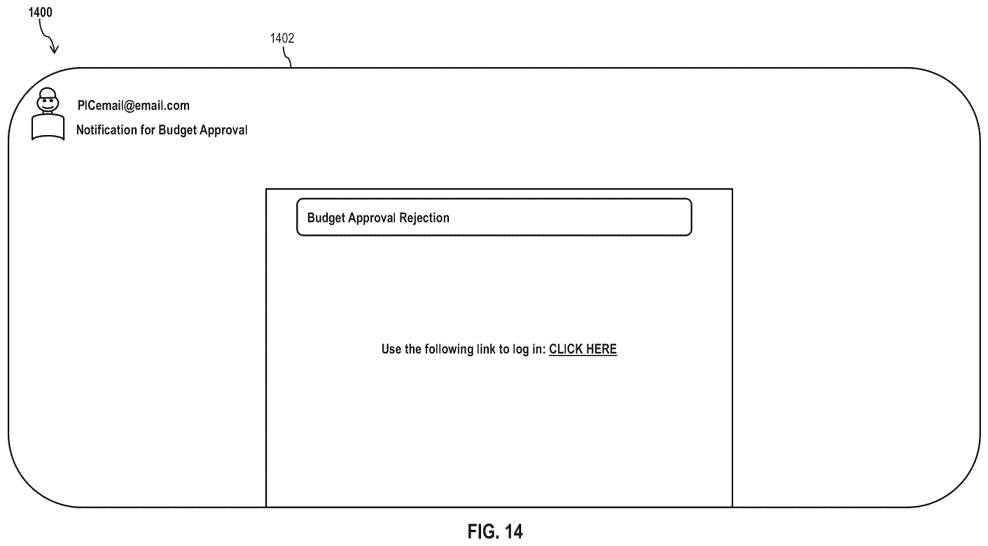

FIG. 14 depicts a budget creation GUI 1400, in accordance with some embodiments.

In some embodiments, for every rejection and approval, a notification email 1402 is sent to the PIC. In some embodiments, other PICs, such as next-tier PICs) who are involved in the budget creation are cc′d on email 1402 as well. In some embodiments, notification email is also sent when a budget is created and submitted.

In some embodiments, a PIC, or the associated personnel (e.g., supervisor or manager of the PIC, other suitable personnel within the contemplated scope of the disclosure) receive an e-mail notification sent by CBMS 100, once CBMS detects there is a change in status of the budget application (e.g., change from pending, approved, rejected, saved, submitted, created, or other suitable status within the contemplated scope of the disclosure).

In some embodiments, a centralized budget management system (CBMS) includes a memory having non-transitory instructions stored therein; and processing circuitry coupled to the memory, and being configured to execute the instructions, thereby causing the processing circuitry to cause a graphical user interface (GUI) to be output by a user interface (UI), the GUI including a first user input field configured to receive a first user input identifying a person-in-charge (PIC) to log in to the CBMS; in response to a successful log in to the CBMS, obtain master data from the memory, the master data being associated with the PIC; the GUI further including a table presentation of each existing budget application associated with the master data of the PIC; a second user input field configured to receive a second user input identifying an existing budget application to manage; a third user input field configured to receive a third user input identifying a draft budget document to import; a fourth user input field configured to receive a fourth user input identifying guided creation of a new budget document; and systematically collect information from one or more of the following: the imported draft budget document; or guided budget inputs; and unify the collected information into a budget.

In some embodiments, the instructions further cause the CBMS to submit the budget to a first-tier PIC for review.

In some embodiments, the instructions further cause the CBMS to in response to the budget receiving approval from the first tier PIC review, automatically forward the approved budget to a second-tier reviewer.

In some embodiments, the GUI, further includes a header indicator indicating a user input field associated with a header that includes the header indicator are to receive a user input identifying information related to the header.

In some embodiments, the GUI, further includes, in response to receiving a fifth user input at a fifth user input field configured to receive the fifth user input, search for related parameters based on the fifth user input.

In some embodiments, each user input field within the GUI further includes a label that identifies information to be input into the user input field.

In some embodiments, the GUI, further includes a sixth user input at a sixth user input field configured to receive an input indicating a document is to be uploaded.

In some embodiments, the instructions further cause the CBMS to determine whether the draft budget document contains each piece of information for the budget.

In some embodiments, the instructions further cause the CBMS to, in response to each piece of information for the budget being within the draft budget document, creating the budget.

In some embodiments, the GUI, further includes an error message indicating information is missing or inaccurate within the draft budget.

In some embodiments, a method executed by a processing circuitry that includes causing a graphical user interface (GUI) to be output by a user interface (UI), the GUI including a first user input field configured to receive a first user input identifying a person-in-charge (PIC) to log in to a centralized budget management system (CBMS); in response to a successful log in to the CBMS, obtaining master data from a non-transitory computer readable medium, the master data associated with the PIC; the GUI further including a table presentation of each existing budget application associated with the master data of the PIC; a second user input field configured to receive a second user input identifying an existing budget application to manage; a third user input field configured to receive a third user input identifying a draft budget document to import; a fourth user input field configured to receive a fourth user input identifying manual creation of a new budget document; and systematically collecting information from one or more of the following, the imported draft budget document; or manual budget inputs; and unifying the collected information into a budget.

In some embodiments, the method further including submitting the budget for review by a first-tier reviewer.

In some embodiments, the method further including, in response to the budget receiving approval from the first-tier review, automatically forwarding the budget to a second-tier review.

In some embodiments, the GUI, further includes a header indicator indicating a user input field associated with a header that includes the header indicator are to receive a user input identifying information related to the header.

In some embodiments, the method further including in response to receiving a fifth user input at a fifth user input field configured to receive the fifth user input, searching for related parameters based on the fifth user input.

In some embodiments, a non-transitory computer readable medium including instructions executable by a controller to cause the controller to perform operations including causing a graphical user interface (GUI) to be output by a user interface (UI), the GUI including a first user input field configured to receive a first user input identifying a person-in-charge (PIC) to log in to a centralized budget management system (CBMS); in response to a successful log in to the CBMS, obtaining master data from the non-transitory computer readable medium, the master data associated with the PIC; the GUI further including a table presentation of each existing budget application associated with the master data of the PIC; a second user input field configured to receive a second user input identifying an existing budget application to manage; a third user input field configured to receive a third user input identifying a draft budget document to import; a fourth user input field configured to receive a fourth user input identifying manual creation of a new budget document; and systematically collecting information from one or more of the following: the imported draft budget document; or manual budget inputs; and unifying the collected information into a budget.

In some embodiments, the instructions further cause the controller to perform submitting the budget for review by a first-tier reviewer.

In some embodiments, the instructions further cause the controller to perform, in response to the budget receiving approval from the first-tier review, automatically forwarding the budget to a second-tier review.

In some embodiments, the GUI, further includes a header indicator indicating a user input field associated with a header that includes the header indicator are to receive a user input identifying information related to the header.

In some embodiments, the instructions further cause the controller to perform, in response to receiving a fifth user input at a fifth user input field configured to receive the fifth user input, searching for related parameters based on the fifth user input.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should further realize that such equivalent constructions do not depart from the spirit and scope of the present disclosure, and that they may make various changes, substitutions, and alterations herein without departing from the spirit and scope of the present disclosure.

What is claimed is:

1. A centralized budget management system (CBMS), comprising:
a memory having non-transitory instructions stored therein; and
processing circuitry coupled to the memory, and being configured to execute the instructions, thereby causing the processing circuitry to:
cause a graphical user interface (GUI) to be output by a user interface (UI), the GUI comprising:
a first user input field configured to receive a first user input identifying a person-in-charge (PIC) to log in to the CBMS;
in response to a successful log in to the CBMS, obtain master data from the memory, the master data being associated with the PIC;
the GUI further comprising:
a table presentation of each existing budget application associated with the master data of the PIC;
a second user input field configured to receive a second user input identifying an existing budget application to manage;
a third user input field configured to receive a third user input identifying a draft budget document to import;
a fourth user input field configured to receive a fourth user input identifying guided creation of a new budget document; and
systematically collect information from one or more of the following:
the imported draft budget document; or
guided budget inputs; and
unify the collected information into a budget.

2. The CBMS system of claim 1, wherein the instructions further cause the CBMS to:
submit the budget to a first-tier PIC for review.

3. The CBMS system of claim 2, wherein the instructions further cause the CBMS to:
in response to the budget receiving approval from the first tier PIC review, automatically forward the approved budget to a second-tier reviewer.

4. The CBMS system of claim 1, wherein the GUI, further comprises:
a header indicator indicating a user input field associated with a header that includes the header indicator are to receive a user input identifying information related to the header.

5. The CBMS system of claim 1, wherein the GUI, further comprises:
in response to receiving a fifth user input at a fifth user input field configured to receive the fifth user input, search for related parameters based on the fifth user input.

6. The CBMS system of claim 1, wherein each user input field within the GUI further includes:
a label that identifies information to be input into the user input field.

7. The CBMS system of claim 1, wherein the GUI, further comprises:
a sixth user input at a sixth user input field configured to receive an input indicating a document is to be uploaded.

8. The CBMS system of claim 1, wherein the instructions further cause the CBMS to:
determine whether the draft budget document contains each piece of information for the budget.

9. The CBMS system of claim 1, wherein the instructions further cause the CBMS to:
in response to each piece of information for the budget being within the draft budget document, creating the budget.

10. The CBMS system of claim 8, wherein the GUI, further comprises:
an error message indicating information is missing or inaccurate within the draft budget.

11. A method executed by a processing circuitry, the method comprising:
causing a graphical user interface (GUI) to be output by a user interface (UI), the GUI comprising:
a first user input field configured to receive a first user input identifying a person-in-charge (PIC) to log in to a centralized budget management system (CBMS);
in response to a successful log in to the CBMS, obtaining master data from a non-transitory computer readable medium, the master data associated with the PIC;
the GUI further comprising:
a table presentation of each existing budget application associated with the master data of the PIC;
a second user input field configured to receive a second user input identifying an existing budget application to manage;
a third user input field configured to receive a third user input identifying a draft budget document to import;
a fourth user input field configured to receive a fourth user input identifying manual creation of a new budget document; and
systematically collecting information from one or more of the following:
the imported draft budget document; or
manual budget inputs; and
unifying the collected information into a budget.

12. The method of claim 11, further comprising:
submitting the budget for review by a first-tier reviewer.

13. The method of claim 12, further comprising:
in response to the budget receiving approval from the first-tier review, automatically forwarding the budget to a second-tier review.

14. The method of claim 11, wherein the GUI, further comprises:
a header indicator indicating a user input field associated with a header that includes the header indicator are to receive a user input identifying information related to the header.

15. The method of claim 11, further comprising:
in response to receiving a fifth user input at a fifth user input field configured to receive the fifth user input, searching for related parameters based on the fifth user input.

16. A non-transitory computer readable medium including instructions executable by a controller to cause the controller to perform operations comprising:
causing a graphical user interface (GUI) to be output by a user interface (UI), the GUI comprising:
a first user input field configured to receive a first user input identifying a person-in-charge (PIC) to log in to a centralized budget management system (CBMS);
in response to a successful log in to the CBMS, obtaining master data from the non-transitory computer readable medium, the master data associated with the PIC;
the GUI further comprising:
a table presentation of each existing budget application associated with the master data of the PIC;
a second user input field configured to receive a second user input identifying an existing budget application to manage;
a third user input field configured to receive a third user input identifying a draft budget document to import;
a fourth user input field configured to receive a fourth user input identifying manual creation of a new budget document; and
systematically collecting information from one or more of the following:
the imported draft budget document; or
manual budget inputs; and
unifying the collected information into a budget.

17. The non-transitory computer readable medium of claim 16, wherein the instructions further cause the controller to perform:
submitting the budget for review by a first-tier reviewer.

18. The non-transitory computer readable medium of claim 17, wherein the instructions further cause the controller to perform:
in response to the budget receiving approval from the first-tier review, automatically forwarding the budget to a second-tier review.

19. The non-transitory computer readable medium of claim 16, wherein the GUI, further comprises:
a header indicator indicating a user input field associated with a header that includes the header indicator are to receive a user input identifying information related to the header.

20. The non-transitory computer readable medium of claim 16, wherein the instructions further cause the controller to perform:
in response to receiving a fifth user input at a fifth user input field configured to receive the fifth user input, searching for related parameters based on the fifth user input.
